(19) United States
(12) Patent Application Publication
(10) Pub. No.: US 2026/0067728 A1
(43) Pub. Date: Mar. 5, 2026

(54) BEAM REPORTING METHOD AND APPARATUS, AND TERMINAL, NETWORK DEVICE AND MEDIUM

(71) Applicant: Beijing Xiaomi Mobile Software Co., Ltd., Beijing (CN)

(72) Inventor: Mingju LI, Beijing (CN)

(21) Appl. No.: 19/106,121

(22) PCT Filed: Sep. 2, 2022
(86) PCT No.: PCT/CN2022/116878

§ 371 Date: Feb. 24, 2025

(51) Int. Cl. H04W 24/10

(52) U.S. Cl. CPC H04W 24/10

(57) ABSTRACT

A beam reporting method is performed by a terminal, and includes: transmitting a beam report, wherein the beam report reports at least one beam identifier, or reports the at least one beam identifier and strength of one or more beam qualities corresponding to the at least one beam identifier.

### CROSS-REFERENCE TO RELATED APPLICATION

This application is the U.S. national phase application of International Application No. PCT/CN2022/116878, filed on Sep. 2, 2022, the disclosure of which is incorporated herein by reference in its entirety.

### TECHNICAL FIELD

The present disclosure relates to the field of communication technologies, and in particular, relates to a beam reporting method and apparatus, a terminal, a network device and a medium.

### BACKGROUND

Due to a fast attenuation of high-frequency channels, beam-based transmissions and receptions are required in communication systems to ensure a coverage range.

In related arts, a base station configures configuration information for beam measurements. A terminal performs the beam measurements based on the configuration information, and obtains beam identifiers and beam qualities corresponding to the beam identifiers and reports them to the base station.

### SUMMARY

The present disclosure provides a beam reporting method and apparatus, a terminal, a network device and a medium. The technical solutions are as follows.

According to one aspect of the present disclosure, a beam reporting method is provided, which is performed by a terminal and includes: transmitting a beam report, wherein the beam report reports at least one beam identifier, or reports the at least one beam identifier and strength of one or more beam qualities corresponding to the at least one beam identifier.

According to another aspect of the present disclosure, a beam reporting method is provided, which is performed by a network device and includes:
receiving a beam report, wherein the beam report reports at least one beam identifier, or reports the at least one beam identifier and strength of one or more beam qualities corresponding to the at least one beam identifier.

According to another aspect of the present disclosure, a terminal is provided, which includes: one or more processors; one or more transceivers connected to the one or more processors; and one or more memories storing executable instructions of the one or more processors. The one or more processors are configured to load and execute the executable instructions to transmit a beam report, wherein the beam report reports at least one beam identifier, or reports the at least one beam identifier and strength of one or more beam qualities corresponding to the at least one beam identifier.

The technical solutions provided in the examples of the present disclosure include at least the following beneficial effects.

According to the methods provided in the examples of the present disclosure, the terminal transmits the beam report which reports at least one beam identifier, or reports at least one beam identifier and the strength of one or more beam qualities corresponding to the at least one beam identifier. The beam report in the examples of the present disclosure is an enhanced beam report, which may indicate the strength of the beam qualities corresponding to the beam identifiers. By adopting the methods in the examples of the present disclosure, the network device can determine the strength of the beam qualities based on the beam report, which is also conducive to establishing beam-directional communications between the network device and the terminal, and adjusting a downlink data rate and a modulation scheme by the network device, etc.

### BRIEF DESCRIPTION OF THE DRAWINGS

The drawings to be used in the description of the examples of the present disclosure are briefly introduced. The drawings in the following description illustrate only some examples of the present disclosure.

FIG. 1 is a schematic diagram of a network architecture provided in an example of the present disclosure.

FIG. 2 is a flowchart of a beam reporting method provided in an example of the present disclosure.

FIG. 3 is a flowchart of a beam reporting method provided in an example of the present disclosure.

FIG. 4 is a structural block diagram of a beam reporting apparatus provided in an example of the present disclosure.

FIG. 5 is a structural block diagram of a beam reporting apparatus provided in an example of the present disclosure.

FIG. 6 is a schematic structural block diagram of a communication device provided in an example of the present disclosure.

### DETAILED DESCRIPTION OF THE EMBODIMENTS

Embodiments of the present disclosure will be further described in detail below in conjunction with the accompanying drawings.

Examples will be described in detail herein, whose illustrations are shown in the accompanying drawings. Where the following descriptions involve the drawings, like numerals in different drawings refer to like or similar elements unless otherwise indicated. The implementations described in the following examples do not represent all implementations consistent with the present disclosure. Rather, they are merely examples of apparatuses and methods consistent with some aspects of the present disclosure as detailed in the appended claims.

The terms used in the present disclosure are for the purpose of describing particular examples only, and are not intended to limit the present disclosure. The terms determined by “a,” “said” and “the” in their singular forms in the present disclosure and the appended claims are also intended to include their plural forms, unless clearly indicated otherwise in the context. It is also to be understood that the term “and/or” as used herein is and includes any and all possible combinations of one or more of the associated listed items.

It is to be understood that, although the terms “first,” “second,” and the like may be adopted in the present disclosure to describe various information, such information should not be limited to these terms. These terms are only used to distinguish the information of the same type with each other. For example, without departing from the scope of the present disclosure, a first parameter may also be referred to as a second parameter, and similarly, a second parameter may also be referred to as a first parameter. Depending on the context, the word “if” as used herein may be interpreted as “when,” “upon,” or “in response to determining”.

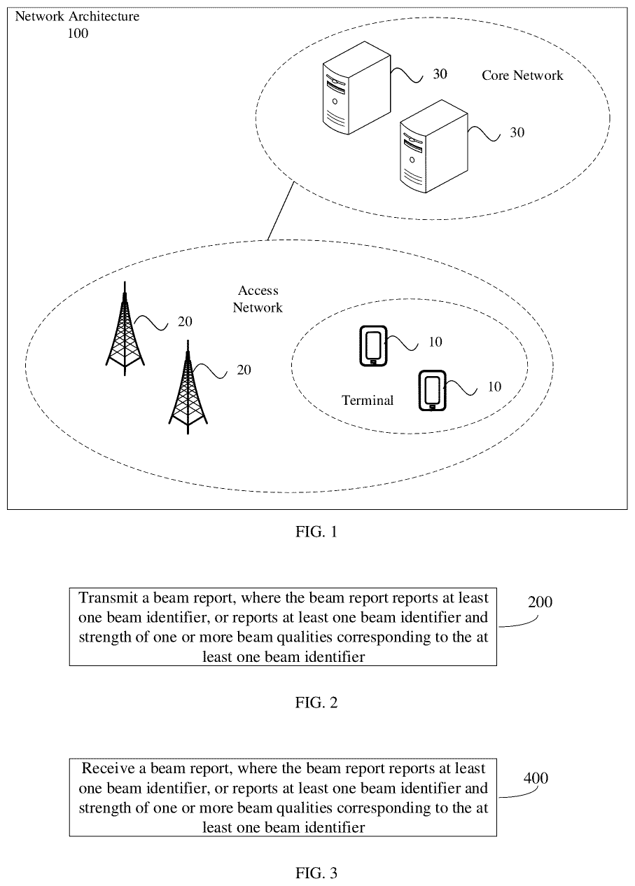

FIG. 1 illustrates a schematic diagram of a network architecture 100 provided in an example of the present disclosure. The network architecture 100 may include: terminals 10, access network devices 20 and core network devices 30.

The terminal 10 may refer to user equipment (UE), an access terminal, a user unit, a user station, a mobile station, a mobile console, a remote station, a remote terminal, a mobile device, a wireless communication device, a user agent or a user device. Alternatively, or additionally, the terminal 10 may be a cellular phone, a cordless phone, a session initiation protocol (SIP) phone, a wireless local loop (WLL) station, a personal digital assistant (PDA), a handheld device with wireless communication functions, a computing device or another processing device connected to a wireless modem, a vehicle-mounted device, a wearable device, a terminal in a fifth generation mobile communication system (5th generation system, 5GS) or a terminal in a future evolved public land mobile communication network (PLMN), etc., which is not limited in the examples of the present disclosure. For the convenience of description, the mentioned devices are collectively referred to as the terminal. The number of terminals 10 is usually more than one. One or more terminals 10 may be distributed in a cell managed by each access network device 20.

The access network device 20 is a device deployed in an access network to provide wireless communication functions for the terminals 10. The network device 20 may include various forms, such as a macro base station, a micro base station, a relay station, and an access point. In systems adopting different wireless access technologies, the device equipped with the access network device functions may have different names. For example, it is called gNodeB or gNB in 5G new radio (NR) systems. As communication technologies evolve, the name “access network device” may change. For ease of description, the described devices for providing the wireless communication functions for the terminals 10 are collectively called the access network device. Alternatively, or additionally, a communication relationship may be established between the terminal 10 and the core network device 30 through the access network device 20. For example, in a long term evolution (LTE) system, one or more access network devices 20 may be an evolved universal terrestrial radio access network (EUTRAN) or one or more eNodeBs in the EUTRAN. In a 5G NR system, one or more access network devices 20 may be a radio access network (RAN) or one or more gNBs in the RAN. In the examples of the present disclosure, the network device, unless otherwise specified, refers to the access network device 20, such as a base station.

The core network device 30 is a device deployed in a core network. The functions of the core network device 30 are mainly to provide user connection, user management and service bearing, and to provide interfaces to an external network as a bearer network. For example, the core network devices in the 5G NR system may include an access and mobility management function (AMF) network element, a user plane function (UPF) network element, a session management function (SMF) network element, etc.

In an example, the access network device 20 and the core network device 30 communicate with each other via a certain air interface technology, e.g., a next generation (NG) interface in the 5G NR system. The access network device 20 and the terminal 10 communicate with each other via a certain air interface technology, e.g., a Uu interface.

For example, the terminal 10 transmits a beam report to the access network device 20, and the access network device 20 receives the beam report. The beam report reports at least one beam identifier. Alternatively, the beam report reports at least one beam identifier and strength of one or more beam qualities corresponding to the at least one beam identifier.

FIG. 2 illustrates a flowchart of a beam reporting method provided in an example of the present disclosure. The example is illustrated by applying the method to a terminal. The method includes step 200.

At step 200, a beam report is transmitted, where the beam report reports at least one beam identifier, or reports at least one beam identifier and strength of one or more beam qualities corresponding to the at least one beam identifier.

In an NR system, especially in a millimeter wave frequency band (i.e., frequency range 2, FR2), beam-based transmissions and receptions are required due to a fast attenuation of high-frequency channels to ensure a coverage range. A beam for signal transmission is called a transmission beam, and a beam for signal reception is called a reception beam.

Alternatively, or additionally, a beam identifier (ID) is represented by at least one of a synchronization signal block (SSB) index, a channel state information reference signal (CSI-RS) index, or a reception beam identifier. The SSB index or the CSI-RS index may be considered as a transmission beam identifier.

Alternatively, or additionally, the beam quality is represented by at least one of a layer 1 reference signal receiving power (L1-RSRP) or a layer 1 signal to interference plus noise ratio (L1-SINR).

In some examples, a network device configures one or more reference signal resource sets for beam measurements. Each reference signal in the one or more reference signal resource sets corresponds to the same or a different transmission beam. The terminal performs the beam measurements based on one or more reference signals in the one or more reference signal resource sets to obtain at least one beam identifier, or obtain at least one beam identifier and one or more beam qualities corresponding to the at least one beam identifier.

Alternatively, or additionally, at least one beam identifier may be a plurality of beam identifiers, and the plurality of beam identifiers mean that at least two beam identifiers are included. One or more beam qualities corresponding to at least part of the plurality of beam identifiers are obtained via the measurements based on one or more reference signals transmitted by the network device.

Alternatively, or additionally, at least part of the plurality of beam identifiers may refer to all or some of the beam identifiers.

For example, at least one beam identifier includes a beam identifier 1 and a beam identifier 2. A beam quality 1 corresponding to the beam identifier 1 and a beam quality 2 corresponding to the beam identifier 2 may both be obtained via the measurements based on one or more reference signals transmitted by the network device. Alternatively, the beam quality 1 corresponding to the beam identifier 1 is obtained via one or more measurements based on one or more reference signals transmitted by the network device.

In some examples, supposing that one or more reference signal resource sets for beam measurements configured by the network device include X reference signals, each reference signal in the one or more reference signal resource sets corresponds to the same or a different transmission beam. For each reference signal, the terminal measures a reception beam based on the reference signal to obtain the beam quality corresponding to the reception beam. In this case, the counts of beam pairs expected to be measured by the terminal are M*N, where M is counts of the transmission beams from the network device and N is counts of the reception beams to the terminal. If the network device is configured with periodic beam measurements and reporting, the terminal is to perform the beam measurements and report the beam qualities based on the reference signals of each period. In order to reduce the counts of beam pairs measured by the terminal, the beam qualities may be predicted based on an artificial intelligence (AI) model.

Alternatively, or additionally, at least one beam identifier is a plurality of beam identifiers, and one or more beam qualities corresponding to at least part of the plurality of beam identifiers are obtained via a prediction based on the AI model.

Alternatively, or additionally, at least part of the plurality of beam identifiers may refer to all or some of the beam identifiers.

As an example, at least one beam identifier includes the beam identifier 1 and the beam identifier 2, and the beam qualities of other beams than a beam 1 and a beam 2 are inputted into the AI model to predict the beam quality 1 corresponding to the beam identifier 1 and the beam quality 2 corresponding to the beam identifier 2 separately or simultaneously.

As another example, at least one beam identifier includes the beam identifier 1 and the beam identifier 2, and the beam quality 1 corresponding to the beam identifier 1 is inputted into the AI model to predict the beam quality 2 corresponding to the beam identifier 2.

Alternatively, or additionally, at least one beam identifier is a plurality of beam identifier, and the beam qualities corresponding respectively to the plurality of beam identifiers may be obtained by a combination of the above two schemes.

For example, one or more beam qualities corresponding to at least one beam identifier among the plurality of beam identifiers are obtained via the measurements based on one or more reference signals transmitted by the network device. The one or more beam qualities corresponding to the at least one beam identifier are inputted into the AI model to predict the beam qualities corresponding to the other beam identifiers among the plurality of beam identifiers.

In some examples, different AI models are obtained by training a to-be-trained AI model according to specific types of data inputted into the AI model, respectively. Different AI models perform different types of data prediction. The training process of the AI model is not limited here.

Alternatively, or additionally, the terminal generates the beam report based on at least one beam identifier, or based on at least one beam identifier and the strength of one or more beam qualities corresponding to the at least one beam identifier.

Alternatively, or additionally, the terminal transmits the beam report. The beam report reports at least one beam identifier, or reports at least one beam identifier and the strength of one or more beam qualities corresponding to the at least one beam identifier. That is, the beam report may only report at least one beam identifier, or may simultaneously report both at least one beam identifier and the strength of one or more beam qualities corresponding to the at least one beam identifier.

Alternatively, or additionally, when the beam report only reports at least one beam identifier, the at least one beam identifier included in the beam report may be one or more beam identifiers whose corresponding beam qualities are greater than a first threshold value, or may be one or more beam identifiers whose corresponding beams have a probability of being the best beam greater than a second threshold value.

In view of the above, according to the method provided in the example of the present disclosure, the terminal transmits the beam report which reports at least one beam identifier, or reports at least one beam identifier and the strength of one or more beam qualities corresponding to the at least one beam identifier. The beam report in the example of the present disclosure is an enhanced beam report, which may indicate the strength of the beam qualities corresponding to the beam identifiers. Therefore, the network device can determine the strength of the beam qualities based on the beam report, which is also conducive to establishing subsequent beam-directional communications between the network device and the terminal, and adjusting a downlink data rate and a modulation scheme by the network device, etc.

In some examples, the beam report includes at least one beam identifier arranged in order. The arrangement order of the at least one beam identifier indicates the strength of one or more beam qualities corresponding to the at least one beam identifier.

Alternatively, or additionally, when at least one beam identifier includes at least two beam identifiers, the terminal sorts the at least two beam identifiers based on the at least two beam identifiers and the strength of beam qualities corresponding to the at least two beam identifiers.

Alternatively, or additionally, the beam report includes at least one beam identifier arranged in order, and the arrangement order of the at least one beam identifier indicates the strength of one or more beam qualities corresponding to the at least one beam identifier.

For example, the beams include the beam 1, the beam 2, and a beam 3. The beam report transmitted by the terminal includes the beam identifier 1, the beam identifier 2, and a beam identifier 3 arranged in order. The arrangement order of the beam identifier 1, the beam identifier 2 and the beam identifier 3 indicates the strength of the beam quality 1, the beam quality 2 and a beam quality 3 corresponding to the beam identifier 1, the beam identifier 2 and the beam identifier 3.

Alternatively, or additionally, the terminal may sort at least two beam identifiers from strong to weak according to the beam qualities corresponding to the at least two beam identifiers.

Alternatively, or additionally, a beam corresponding to a first beam identifier is the best beam, where the first beam identifier is sorted as the first one of the at least one beam identifier in the beam report. The best beam means a beam with the strongest beam quality.

Alternatively, or additionally, the first beam identifier is sorted as the first one of at least one beam identifier in the beam report, and the probability that the beam corresponding to the first beam identifier is the best beam is a maximum value of one or more probabilities that one or more beams corresponding to the at least one beam identifier are the best beam separately.

For example, the beams include the beam 1, the beam 2 and the beam 3, and the beam report transmitted by the terminal includes the beam identifier 1, the beam identifier 2 and the beam identifier 3 arranged in order. The beam quality 1, the beam quality 2 and the beam quality 3 corresponding to the beam identifier 1, the beam identifier 2 and the beam identifier 3 are from strong to weak. The beam 1 corresponds to the beam identifier 1 that is sorted as the first one, and the probability that the beam 1 is the best beam is the maximum value of the probabilities that these three beams are the best beam separately. Therefore, the first beam identifier is the beam identifier 1, and the beam 1 corresponding to the beam identifier 1 is the best beam.

In some examples, the beam corresponding to the first beam identifier is the best beam, and the beam identifier corresponding to the best beam is obtained via the prediction based on the AI model. In this case, the network device may further transmit one or more reference signals corresponding to the best beam identifier again, and the terminal performs one or more beam measurements based on the one or more reference signals to obtain the beam quality of the best beam, thereby further improving the accuracy.

For example, the beams include the beam 1, the beam 2, and the beam 3. The beam report transmitted by the terminal includes the beam identifier 1, the beam identifier 2, and the beam identifier 3 arranged in order. When the first beam identifier is the beam identifier 1, the beam 1 corresponding to the beam identifier 1 is the best beam. In a case where the beam identifier corresponding to the beam 1 is obtained via the prediction based on the AI model, the network device may further transmit one or more reference signals corresponding to the beam 1 again. The terminal performs one or more beam measurements based on the one or more reference signals to obtain the beam quality of the beam 1, including at least one of the L1-RSRP or the L1-SINR.

In some examples, the above example is applicable to a none-group based reporting scenario.

In the example, the beam report includes at least one beam identifier arranged in order, and the arrangement order of the at least one beam identifier indicates the strength of one or more beam qualities corresponding to the at least one beam identifier. Therefore, the network device can learn which beam has the strongest beam quality based on the arrangement order of the beam identifiers, thereby improving the efficiency of the network device in determining the beam with the strongest beam quality.

In some examples, the beam report includes at least one beam identifier, and includes the probability that each of one or more beams corresponding to the at least one beam identifier is the best beam.

Alternatively, or additionally, the probability that each of one or more beams corresponding to at least one beam identifier is the best beam may be obtained via a calculation based on the one or more beam qualities corresponding to the at least one beam identifier, may be directly obtained via a prediction based on the AI model, or may be a combination of the above two schemes.

In an example, the probability that each of one or more beams corresponding to the at least one beam identifier is the best beam includes:
an absolute value of the probability that each of one or more beams corresponding to the at least one beam identifier is the best beam;
or,
an absolute value of a first probability that the beam corresponding to a first beam identifier among the at least one beam identifier is the best beam, and a relative value of the probability that each of one or more beams corresponding to one or more other beam identifiers among the at least one beam identifier is the best beam with respect to the first probability.

For example, the probability includes an absolute probability and a relative probability. Supposing that a set U is defined as a set of objective worlds (being an infinite and uncountable set), and a set S is a maximal set of research objects. The absolute probability refers to a probability that a defined domain falls into the U, which does not change with the change of S. The relative probability refers to a probability that the defined domain falls into the S. Different defined domains directly lead to different relative probabilities.

Alternatively, or additionally, the absolute probability is also called an absolute value of probability. The probability that each of one or more beams corresponding to the at least one beam identifier is the best beam may include the absolute value of the probability that each of the one or more beams corresponding to the at least one beam identifier is the best beam. The best beam means the beam with the strongest beam quality.

For example, the beams include the beam 1, the beam 2 and the beam 3. All of the probability 1, probability 2 and probability 3, which are the probabilities that the beam 1 corresponding to the beam identifier 1, the beam 2 corresponding to the beam identifier 2 and the beam 3 corresponding to the beam identifier 3 are the best beam separately, are the absolute values of probability. The probability 1 is 90%, the probability 2 is 70%, and the probability 3 is 60%.

Alternatively, or additionally, the relative probability is also called a relative value of probability. At least one beam identifier is divided into a first beam identifier and other beam identifiers. When the probabilities that one or more beams corresponding to at least one beam identifier is the best beam separately may include the absolute value of the first probability that the beam corresponding to the first beam identifier among the at least one beam identifier is the best beam, they may also include the relative value of the probability that each of one or more beams corresponding to one or more other beam identifiers among the at least one beam identifier is the best beam with respect to the first probability.

Alternatively, or additionally, the probability that the beam corresponding to the first beam identifier is the best beam is a maximum value of one or more probabilities that one or more beams corresponding to the at least one beam identifier are the best beam separately.

For example, the beams include the beam 1, the beam 2 and the beam 3, and the best beam is the beam 1. The first beam identifier refers to the beam identifier 1 corresponding to the beam 1. The probability 1 (the first probability) that the beam 1 corresponding to the beam identifier 1 is the best beam is the absolute value of probability, 90%. The probability 2 that the beam 2 corresponding to the beam identifier 2 is the best beam has the absolute value of 70%. Thus, the relative value of the probability 2 with respect to the first probability is 20%. The probability 3 that the beam 3 corresponding to the beam identifier 3 is the best beam has the absolute value of 60%. Thus, the relative value of the probability 3 with respect to the first probability is 30%.

Alternatively, or additionally, in the case where the beam report includes at least one beam identifier and the probability that each of one or more beams corresponding to the at least one beam identifier is the best beam, the at least one beam identifier may be arranged in order or in no order, which is not limited here.

In some examples, the above example is applicable to a group based reporting scenario.

In some examples, in the group based reporting scenario, at least one beam identifier includes at least two beam identifiers, and the at least two beam identifiers are divided into at least two beam identifier groups. The group sorted as the first one in the beam report is a group in which the first beam identifier is located. The reference signals corresponding to the beam identifiers in the same group belong to different channel measurement resource (CMR) sets.

Alternatively, or additionally, the group based beam reporting means that the terminal reports the beams based on different groups. The probability that the beam corresponding to the first beam identifier is the best beam is the maximum value of the probabilities that the beams corresponding to at least two beam identifiers are the best beam separately. Thus, the group sorted as the first one in the beam report is the group in which the first beam identifier is located.

For example, the beam report includes three groups, namely group #1, group #2 and group #3. The group #1 is sorted as the first one and includes the beam identifiers RS ID #11 and RS ID #12. The group #2 is sorted as the second one and includes the beam identifiers RS ID #21 and RS ID #22. The group #3 is sorted as the third one and includes the beam identifiers RS ID #31 and RS ID #32. The first beam identifier is RS ID #11, that is, the group sorted as the first one is the group in which the first beam identifier is located.

Alternatively, or additionally, the beam identifiers in the same group belong to different CMR sets, respectively.

For example, the group #1 sorted as the first one in the beam report includes the beam identifiers RS ID #11 and RS ID #12, with RS ID #11 being the first beam identifier. The group #2 sorted as the second one includes the beam identifiers RS ID #21 and RS ID #22. The group #3 sorted as the third one includes the beam identifiers RS ID #31 and RS ID #32. RS ID #11, RS ID #21 and RS ID #31 belong to the same CMR Set #1, and RS ID #12, RS ID #22 and RS ID #32 belong to the same CMR Set #2. The RS IDs in the same group belong to different CMR Sets.

In some examples, in the group based beam reporting scenario, the terminal has an ability to simultaneously receive multiple downlink transmission beams.

In the example, the beam report includes at least one beam identifier and the probability that each of one or more beams corresponding to the at least one beam identifier is the best beam. Therefore, the network device can determine which beam has the strongest beam quality based on the probabilities, which improves the efficiency of the network device in determining the beam with the strongest beam quality.

FIG. 3 illustrates a flowchart of a beam reporting method provided in an example of the present disclosure. The example is illustrated by applying the method to a network device. The method further includes step 400.

At step 400, a beam report is received, where the beam report reports at least one beam identifier, or reports at least one beam identifier and strength of one or more beam qualities corresponding to the at least one beam identifier.

Alternatively, or additionally, a beam identifier is represented by at least one of an SSB index, a CSI-RS index, or a reception beam identifier. The SSB index or the CSI-RS index may be considered as a transmission beam identifier.

Alternatively, or additionally, the beam quality is represented by at least one of an L1-RSRP or an L1-SINR.

In some examples, the network device configures one or more reference signal resource sets for beam measurements. Each reference signal in the one or more reference signal resource sets corresponds to the same or a different transmission beam. The terminal performs the beam measurements based on one or more reference signals in the one or more reference signal resource sets to obtain at least one beam identifier, or obtain at least one beam identifier and one or more beam qualities corresponding to the at least one beam identifier.

Alternatively, or additionally, in the beam report received by the network device, at least one beam identifier may be a plurality of beam identifiers, and the plurality of beam identifiers mean that at least two beam identifiers are included. One or more beam qualities corresponding to at least part of the plurality of beam identifiers are obtained via the measurements based on one or more reference signals transmitted by the network device.

Alternatively, or additionally, at least part of the plurality of beam identifiers may refer to all or some of the beam identifiers.

For example, at least one beam identifier includes a beam identifier 1 and a beam identifier 2. A beam quality 1 corresponding to the beam identifier 1 and a beam quality 2 corresponding to the beam identifier 2 may both be obtained via the measurements based on one or more reference signals transmitted by the network device. Alternatively, the beam quality 1 corresponding to the beam identifier 1 is obtained via one or more measurements based on one or more reference signals transmitted by the network device.

In some examples, supposing that one or more reference signal resource sets for beam measurements configured by the network device include x reference signals, each reference signal in the one or more reference signal resource sets corresponds to the same or a different transmission beam. For each reference signal, the terminal measures a reception beam based on the reference signal to obtain the beam quality corresponding to the reception beam. In this case, the counts of beam pairs expected to be measured by the terminal are M*N, where M is counts of the transmission beams from the network device and N is counts of the reception beams to the terminal. If the network device is configured with periodic beam measurements and reporting, the terminal is to perform the beam measurements and report the beam qualities based on the reference signals of each period. In order to reduce the counts of beam pairs measured by the terminal, the beam qualities may be predicted based on an AI model.

Alternatively, or additionally, at least one beam identifier is a plurality of beam identifiers, and one or more beam qualities corresponding to at least part of the plurality of beam identifiers are obtained via a prediction based on the AI model.

Alternatively, or additionally, at least part of the plurality of beam identifiers may refer to all or some of the beam identifiers.

As an example, at least one beam identifier includes the beam identifier 1 and the beam identifier 2, and the beam qualities of other beams than a beam 1 and a beam 2 are inputted into the AI model to predict the beam quality 1 corresponding to the beam identifier 1 and the beam quality 2 corresponding to the beam identifier 2 separately or simultaneously.

As another example, at least one beam identifier includes the beam identifier 1 and the beam identifier 2. The terminal inputs the beam quality 1 corresponding to the beam identifier 1 into the AI model to predict the beam quality 2 corresponding to the beam identifier 2.

Alternatively, or additionally, at least one beam identifier is a plurality of beam identifier, and the beam qualities corresponding respectively to the plurality of beam identifiers may be obtained by a combination of the above two schemes.

For example, one or more beam qualities corresponding to at least one beam identifier among the plurality of beam identifiers are obtained via the measurements based on one or more reference signals transmitted by the network device. The one or more beam qualities corresponding to the at least one beam identifier are inputted into the AI model to predict the beam qualities corresponding to the other beam identifiers among the plurality of beam identifiers.

In some examples, different AI models are obtained by training a to-be-trained AI model according to specific types of data inputted into the AI model, respectively. Different AI models perform different types of data prediction. The training process of the AI model is not limited here.

Alternatively, or additionally, the terminal generates the beam report based on at least one beam identifier, or based on at least one beam identifier and the strength of one or more beam qualities corresponding to the at least one beam identifier.

Alternatively, or additionally, the terminal transmits the beam report, and the network device receives the beam report. The beam report reports at least one beam identifier, or reports at least one beam identifier and the strength of one or more beam qualities corresponding to the at least one beam identifier. That is, the beam report may only report at least one beam identifier, or may simultaneously report both at least one beam identifier and the strength of one or more beam qualities corresponding to the at least one beam identifier.

Alternatively, or additionally, when the beam report only reports at least one beam identifier, the at least one beam identifier included in the beam report may be one or more beam identifiers whose corresponding beam qualities are greater than a first threshold value, or may be one or more beam identifiers whose corresponding beams have a probability of being the best beam greater than a second threshold value.

In view of the above, according to the method provided in the example of the present disclosure, the terminal transmits the beam report which reports at least one beam identifier, or reports at least one beam identifier and the strength of one or more beam qualities corresponding to the at least one beam identifier. The beam report in the example of the present disclosure is an enhanced beam report, which may indicate the strength of the beam qualities corresponding to the beam identifiers. Therefore, the network device can determine the strength of the beam qualities based on the beam report, which is also conducive to establishing subsequent beam-directional communications between the network device and the terminal, and adjusting a downlink data rate and a modulation scheme by the network device, etc.

In some examples, the beam report received by the network device includes at least one beam identifier arranged in order. The arrangement order of the at least one beam identifier indicates the strength of one or more beam qualities corresponding to the at least one beam identifier.

Alternatively, or additionally, when at least one beam identifier includes at least two beam identifiers, the terminal sorts the at least two beam identifiers based on the at least two beam identifiers and the strength of beam qualities corresponding to the at least two beam identifiers.

Alternatively, or additionally, the beam report includes at least one beam identifier arranged in order, and the arrangement order of the at least one beam identifier indicates the strength of one or more beam qualities corresponding to the at least one beam identifier.

For example, the beams include the beam 1, the beam 2, and a beam 3. The beam report transmitted by the terminal includes the beam identifier 1, the beam identifier 2, and a beam identifier 3 arranged in order. The arrangement order of the beam identifier 1, the beam identifier 2 and the beam identifier 3 indicates the strength of the beam quality 1, the beam quality 2 and a beam quality 3 corresponding to the beam identifier 1, the beam identifier 2 and the beam identifier 3.

Alternatively, or additionally, the terminal may sort at least two beam identifiers from strong to weak according to the beam qualities corresponding to the at least two beam identifiers.

Alternatively, or additionally, a beam corresponding to a first beam identifier is the best beam, where the first beam identifier is sorted as the first one of the at least one beam identifier in the beam report. The best beam means a beam with the strongest beam quality.

Alternatively, or additionally, the first beam identifier is sorted as the first one of at least one beam identifier in the beam report, and the probability that the beam corresponding to the first beam identifier is the best beam is a maximum value of one or more probabilities that one or more beams corresponding to the at least one beam identifier are the best beam separately.

For example, the beams include the beam 1, the beam 2 and the beam 3, and the beam report transmitted by the terminal includes the beam identifier 1, the beam identifier 2 and the beam identifier 3 arranged in order. The beam quality 1, the beam quality 2 and the beam quality 3 corresponding to the beam identifier 1, the beam identifier 2 and the beam identifier 3 are from strong to weak. The beam 1 corresponds to the beam identifier 1 that is sorted as the first one, and the probability that the beam 1 is the best beam is the maximum value of the probabilities that these three beams are the best beam separately. Therefore, the first beam identifier is the beam identifier 1, and the beam 1 corresponding to the beam identifier 1 is the best beam.

In some examples, the beam corresponding to the first beam identifier is the best beam, and the beam identifier corresponding to the best beam is obtained via the prediction based on the AI model. In this case, the network device may further transmit one or more reference signals corresponding to the best beam identifier again, and the terminal performs one or more beam measurements based on the one or more reference signals to obtain the beam quality of the best beam, thereby further improving the accuracy.

For example, the beams include the beam 1, the beam 2, and the beam 3. The beam report transmitted by the terminal includes the beam identifier 1, the beam identifier 2, and the beam identifier 3 arranged in order. When the first beam identifier is the beam identifier 1, the beam 1 corresponding to the beam identifier 1 is the best beam. In a case where the beam identifier corresponding to the beam 1 is obtained via the prediction based on the AI model, the network device may further transmit one or more reference signals corresponding to the beam 1 again. The terminal performs one or more beam measurements based on the one or more reference signals to obtain the beam quality of the beam 1, including at least one of the L1-RSRP or the L1-SINR.

In some examples, the above example is applicable to a none-group based reporting scenario.

In the example, the beam report includes at least one beam identifier arranged in order, and the arrangement order of the at least one beam identifier indicates the strength of one or more beam qualities corresponding to the at least one beam identifier. Therefore, the network device can learn which beam has the strongest beam quality based on the arrangement order of the beam identifiers, thereby improving the efficiency of the network device in determining the beam with the strongest beam quality.

In some examples, the beam report received by the network device includes at least one beam identifier, and includes the probability that each of one or more beams corresponding to the at least one beam identifier is the best beam.

Alternatively, or additionally, the probability that each of one or more beams corresponding to at least one beam identifier is the best beam may be obtained via a calculation based on the one or more beam qualities corresponding to the at least one beam identifier, may be directly obtained via a prediction based on the AI model, or may be a combination of the above two schemes.

In an example, the probability that each of one or more beams corresponding to the at least one beam identifier is the best beam includes:
an absolute value of the probability that each of one or more beams corresponding to the at least one beam identifier is the best beam;
or,
an absolute value of a first probability that the beam corresponding to a first beam identifier among the at least one beam identifier is the best beam, and a relative value of the probability that each of one or more beams corresponding to one or more other beam identifiers among the at least one beam identifier is the best beam with respect to the first probability.

For example, the probability includes an absolute probability and a relative probability. Supposing that a set U is defined as a set of objective worlds (being an infinite and uncountable set), and a set S is a maximal set of research objects. The absolute probability refers to a probability that a defined domain falls into the U, which does not change with the change of S. The relative probability refers to a probability that the defined domain falls into the S. Different defined domains directly lead to different relative probabilities.

Alternatively, or additionally, the absolute probability is also called an absolute value of probability. The probability that each of one or more beams corresponding to the at least one beam identifier is the best beam may include the absolute value of the probability that each of the one or more beams corresponding to the at least one beam identifier is the best beam. The best beam means the beam with the strongest beam quality.

For example, the beams include the beam 1, the beam 2 and the beam 3. All of the probability 1, probability 2 and probability 3, which are the probabilities that the beam 1corresponding to the beam identifier 1, the beam 2 corresponding to the beam identifier 2 and the beam 3 corresponding to the beam identifier 3 are the best beam separately, are the absolute values of probability. The probability 1 is 90%, the probability 2 is 70%, and the probability 3is 60%.

Alternatively, or additionally, the relative probability is also called a relative value of probability. At least one beam identifier is divided into a first beam identifier and other beam identifiers. When the probabilities that one or more beams corresponding to at least one beam identifier is the best beam separately may include the absolute value of the first probability that the beam corresponding to the first beam identifier among the at least one beam identifier is the best beam, they may also include the relative value of the probability that each of one or more beams corresponding to one or more other beam identifiers among the at least one beam identifier is the best beam with respect to the first probability.

Alternatively, or additionally, the probability that the beam corresponding to the first beam identifier is the best beam is a maximum value of one or more probabilities that one or more beams corresponding to the at least one beam identifier are the best beam separately.

For example, the beams include the beam 1, the beam 2 and the beam 3, and the best beam is the beam 1. The first beam identifier refers to the beam identifier 1 corresponding to the beam 1. The probability 1 (the first probability) that the beam 1 corresponding to the beam identifier 1 is the best beam is the absolute value of probability, 90%. The probability 2 that the beam 2 corresponding to the beam identifier 2 is the best beam has the absolute value of 70%. Thus, the relative value of the probability 2 with respect to the first probability is 20%. The probability 3 that the beam 3 corresponding to the beam identifier 3 is the best beam has the absolute value of 60%. Thus, the relative value of the probability 3 with respect to the first probability is 30%.

Alternatively, or additionally, in the case where the beam report includes at least one beam identifier and the probability that each of one or more beams corresponding to the at least one beam identifier is the best beam, the at least one beam identifier may be arranged in order or in no order, which is not limited here.

In some examples, the above example is applicable to a group based reporting scenario.

In some examples, in the group based reporting scenario, at least one beam identifier includes at least two beam identifiers, and the at least two beam identifiers are divided into at least two beam identifier groups. The group sorted as the first one in the beam report is a group in which the first beam identifier is located. The reference signals corresponding to the beam identifiers in the same group belong to different channel measurement resource (CMR) sets.

Alternatively, or additionally, the group based beam reporting means that the terminal reports the beams based on different groups. The probability that the beam corresponding to the first beam identifier is the best beam is the maximum value of the probabilities that the beams corresponding to at least two beam identifiers are the best beam separately. Thus, the group sorted as the first one in the beam report is the group in which the first beam identifier is located.

For example, the beam report includes three groups, namely group #1, group #2 and group #3. The group #1 is sorted as the first one and includes the beam identifiers RS ID #11 and RS ID #12. The group #2 is sorted as the second one and includes the beam identifiers RS ID #21 and RS ID #22. The group #3 is sorted as the third one and includes the beam identifiers RS ID #31 and RS ID #32. The first beam identifier is RS ID #11, that is, the group sorted as the first one is the group in which the first beam identifier is located.

Alternatively, or additionally, the beam identifiers in the same group belong to different CMR sets, respectively.

For example, the group #1 sorted as the first one in the beam report includes the beam identifiers RS ID #11 and RS ID #12, with RS ID #11 being the first beam identifier. The group #2 sorted as the second one includes the beam identifiers RS ID #21 and RS ID #22. The group #3 sorted as the third one includes the beam identifiers RS ID #31 and RS ID #32. RS ID #11, RS ID #21 and RS ID #31 belong to the same CMR Set #1, and RS ID #12, RS ID #22 and RS ID #32 belong to the same CMR Set #2. The RS IDs in the same group belong to different CMR Sets.

In some examples, in the group based beam reporting scenario, the terminal has an ability to simultaneously receive multiple downlink transmission beams.

In the example, the beam report includes at least one beam identifier, and the probability that each of one or more beams corresponding to the at least one beam identifier is the best beam. Therefore, the network device can determine which beam has the strongest beam quality based on the probabilities, which improves the efficiency of the network device in determining the beam with the strongest beam quality.

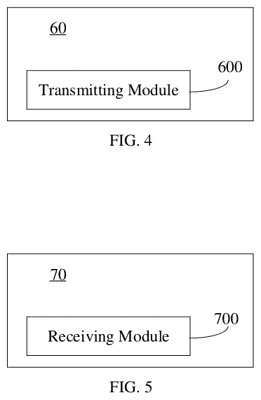

FIG. 4 illustrates a structural block diagram of a beam reporting apparatus 60 provided in an example of the present disclosure. The apparatus 60 includes a transmitting module 600.

The transmitting module 600 is configured to transmit a beam report. The beam report reports at least one beam identifier, or reports at least one beam identifier and strength of one or more beam qualities corresponding to the at least one beam identifier.

In an example, the beam report includes: the at least one beam identifier in an arrangement order.

The arrangement order of the at least one beam identifier indicates the strength of the one or more beam qualities corresponding to the at least one beam identifier.

In an example, the beam corresponding to a first beam identifier is the best beam, where the first beam identifier is sorted as the first one of the at least one beam identifier.

In an example, the beam report includes: the at least one beam identifier, and a probability that each of one or more beams corresponding to the at least one beam identifier is the best beam.

In an example, the probability that each of the one or more beams corresponding to the at least one beam identifier is the best beam includes:
an absolute value of the probability that each of the one or more beams corresponding to the at least one beam identifier is the best beam;
or,
an absolute value of a first probability that the beam corresponding to a first beam identifier among the at least one beam identifier is the best beam, and a relative value of the probability that each of one or more beams corresponding to one or more other beam identifiers among the at least one beam identifier is the best beam with respect to the first probability.

In an example, the probability that the beam corresponding to the first beam identifier is the best beam is a maximum value of one or more probabilities that the one or more beams corresponding to the at least one beam identifier are the best beam separately.

In an example, the at least one beam identifier includes at least two beam identifiers divided into at least two beam identifier groups in a group based beam reporting scenario.

The group sorted as the first one in the beam report is the group in which the first beam identifier is located, and the beam identifiers in the same group belong to different channel measurement resource sets, respectively.

In an example, the beam identifier is represented by at least one of an SSB index, a CSI-RS index, or a reception beam identifier.

In an example, the at least one beam identifier is a plurality of beam identifiers, and one or more beam qualities corresponding to at least part of the plurality of beam identifiers are obtained via a prediction based on an AI model.

In an example, the at least one beam identifier is a plurality of beam identifiers, and one or more beam qualities corresponding to at least part of the plurality of beam identifiers are obtained via measurements based on one or more reference signals transmitted by a network device.

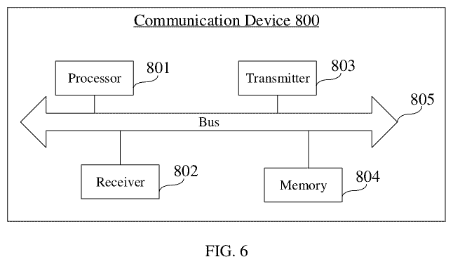

FIG. 5 illustrates a structural block diagram of a beam reporting apparatus 70 provided in an example of the present disclosure. The apparatus 70 includes a receiving module 700.

The receiving module 700 is configured to receive a beam report. The beam report reports at least one beam identifier, or reports at least one beam identifier and strength of one or more beam qualities corresponding to the at least one beam identifier.

In an example, the beam report includes: the at least one beam identifier in an arrangement order.

The arrangement order of the at least one beam identifier indicates the strength of the one or more beam qualities corresponding to the at least one beam identifier.

In an example, the beam corresponding to a first beam identifier is the best beam, where the first beam identifier is sorted as the first one of the at least one beam identifier.

In an example, the beam report includes: the at least one beam identifier, and a probability that each of one or more beams corresponding to the at least one beam identifier is the best beam.

In an example, the probability that each of the one or more beams corresponding to the at least one beam identifier is the best beam includes:
an absolute value of the probability that each of the one or more beams corresponding to the at least one beam identifier is the best beam;
or,
an absolute value of a first probability that the beam corresponding to a first beam identifier among the at least one beam identifier is the best beam, and a relative value of the probability that each of one or more beams corresponding to one or more other beam identifiers among the at least one beam identifier is the best beam with respect to the first probability.

In an example, the probability that the beam corresponding to the first beam identifier is the best beam is a maximum value of one or more probabilities that the one or more beams corresponding to the at least one beam identifier are the best beam separately.

In an example, the at least one beam identifier includes at least two beam identifiers divided into at least two beam identifier groups in a group based beam reporting scenario.

The group sorted as the first one in the beam report is the group in which the first beam identifier is located, and the beam identifiers in the same group belong to different channel measurement resource sets, respectively.

In an example, the beam identifier is represented by at least one of an SSB index, a CSI-RS index, or a reception beam identifier.

In an example, the at least one beam identifier is a plurality of beam identifiers, and one or more beam qualities corresponding to at least part of the plurality of beam identifiers are obtained via a prediction based on an AI model.

In an example, the at least one beam identifier is a plurality of beam identifiers, and one or more beam qualities corresponding to at least part of the plurality of beam identifiers are obtained via measurements based on one or more reference signals transmitted by the network device.

FIG. 6 illustrates a schematic structural diagram of a communication device (a terminal or a network device) provided in an example of the present disclosure. The communication device 800 includes: a processor 801, a receiver 802, a transmitter 803, a memory 804 and a bus 805.

The processor 801 includes one or more processing cores. The processor 801 performs various functional applications and information processing by running software programs and modules.

The receiver 802 and the transmitter 803 may be implemented as a communication component, which may be a communication chip.

The memory 804 is connected to the processor 801 through the bus 805. The memory 804 may be configure to store at least one instruction, and the processor 801 is configured to execute the at least one instruction to implement various steps in the method examples described above.

In addition, the memory 804 may be implemented by any type of volatile or non-volatile storage device or a combination thereof. The volatile or non-volatile storage device includes but is not limited to: a magnetic disk or an optical disk, an electrically erasable programmable read-only memory (EEPROM), an erasable and programmable read-only memory (EPROM), a static random access memory (SRAM), a read-only memory (ROM), a magnetic memory, a flash memory, or a programmable read-only memory (PROM).

Those skilled in the art may understand that the structure illustrated in FIG. 6 does not limit the communication device 800, which may include more or fewer components than illustrated in the drawings, or combine certain components, or adopt a different component arrangement.

In an example, the present disclosure provides a communication chip, which includes a programmable logic circuit and/or program instructions. When run on the terminal or the network device, the communication chip is used to implement the beam reporting methods described above.

The present disclosure provides a computer-readable storage medium, in which at least one instruction, at least one program, a code set or an instruction set is stored. The at least one instruction, the at least one program, the code set or the instruction set is loaded and executed by one or more processors to implement the beam reporting methods provided in the method examples described above.

The present disclosure provides a computer program product or a computer program. The computer program product or the computer program includes computer instructions stored in a computer-readable storage medium. One or more processors obtain the computer instructions from the computer-readable storage medium, so that the one or more processors load and execute the computer instructions to implement the beam reporting methods provided in the method examples described above.

The serial numbers of the foregoing examples of the present disclosure are for description only and do not represent the advantages or disadvantages of the examples.

Persons of ordinary skill in the art may understand that the implementation of all or part of the steps in the foregoing examples may be accomplished by hardware or by instructing related hardware through a program. The program may be stored in a computer-readable storage medium. The mentioned storage medium may be a read-only memory, a disk or an optical disk, etc.

Those skilled in the art should be appreciated that in one or more foregoing examples, the function described in the examples of the present disclosure may be implemented in hardware, software, firmware, or any combination thereof. When implemented in software, these functions may be stored in a computer-readable medium or transmitted as one or more instructions or codes of the computer-readable medium. The computer-readable medium includes a computer storage medium and a communication medium. The communication medium includes any medium that facilitates the transmission of a computer program from one place to another. The storage medium may be any available medium that can be accessed by a general-purpose or special-purpose computer.

The above are only examples of the present disclosure, and are not intended to limit the present disclosure. Any modifications, equivalent replacements, improvements, etc. made within the spirit and principles of the present disclosure shall be included in the protection scope of the present disclosure.

1. A beam reporting method, performed by a terminal, comprising:
transmitting a beam report, wherein the beam report reports at least one beam identifier, or reports the at least one beam identifier and strength of one or more beam qualities corresponding to the at least one beam identifier.

2. The method according to claim 1, wherein the beam report comprises:
the at least one beam identifier in an arrangement order;
wherein the arrangement order of the at least one beam identifier indicates the strength of the one or more beam qualities corresponding to the at least one beam identifier.

3. The method according to claim 2, wherein a beam corresponding to a first beam identifier is a best beam, wherein the first beam identifier is sorted as a first one of the at least one beam identifier.

4. The method according to claim 1, wherein the beam report comprises:
the at least one beam identifier, and
a probability that each of one or more beams corresponding to the at least one beam identifier is a best beam.

5. The method according to claim 4, wherein the probability that each of the one or more beams corresponding to the at least one beam identifier is the best beam comprises:
an absolute value of the probability that each of the one or more beams corresponding to the at least one beam identifier is the best beam;
or,
an absolute value of a first probability that a beam corresponding to a first beam identifier among the at least one beam identifier is the best beam, and a relative value of a probability that each of one or more beams corresponding to one or more other beam identifiers among the at least one beam identifier is the best beam with respect to the first probability.

6. The method according to claim 5, wherein the probability that the beam corresponding to the first beam identifier is the best beam is a maximum value of one or more probabilities that the one or more beams corresponding to the at least one beam identifier are the best beam separately.

7. The method according to claim 5, wherein the at least one beam identifier comprises at least two beam identifiers divided into at least two beam identifier groups in a group based beam reporting scenario;
wherein a group sorted as a first one in the beam report is a group in which the first beam identifier is located, and
wherein beam identifiers in a same group belong to different channel measurement resource sets, respectively.

8. The method according claim 1, wherein the beam identifier is represented by at least one of a synchronization signal block (SSB) index, a channel state information reference signal (CSI-RS) index, or a reception beam identifier.

9. The method according to claim 1, wherein the at least one beam identifier is a plurality of beam identifiers, and wherein one or more beam qualities corresponding to at least part of the plurality of beam identifiers are obtained via a prediction based on an artificial intelligence (Al) model or via measurements based on one or more reference signals transmitted by a network device.

10. (canceled)

11. A beam reporting method, performed by a network device, comprising:
receiving a beam report, wherein the beam report reports at least one beam identifier, or reports the at least one beam identifier and strength of one or more beam qualities corresponding to the at least one beam identifier.

12. The method according to claim 11, wherein the beam report comprises:
the at least one beam identifier in an arrangement order;
wherein the arrangement order of the at least one beam identifier indicates the strength of the one or more beam qualities corresponding to the at least one beam identifier.

13. The method according to claim 12, wherein a beam corresponding to a first beam identifier is a best beam, wherein the first beam identifier is sorted as a first one of the at least one beam identifier.

14. The method according to claim 11, wherein the beam report comprises:
the at least one beam identifier, and
a probability that each of one or more beams corresponding to the at least one beam identifier is a best beam.

15. The method according to claim 14, wherein the probability that each of the one or more beams corresponding to the at least one beam identifier is the best beam comprises:
an absolute value of the probability that each of the one or more beams corresponding to the at least one beam identifier is the best beam;
or,
an absolute value of a first probability that a beam corresponding to a first beam identifier among the at least one beam identifier is the best beam, and a relative value of a probability that each of one or more beams corresponding to one or more other beam identifiers among the at least one beam identifier is the best beam with respect to the first probability.

16. The method according to claim 15, wherein the probability that the beam corresponding to the first beam identifier is the best beam is a maximum value of one or more probabilities that the one or more beams corresponding to the at least one beam identifier are the best beam separately.

17. The method according to claim 15, wherein the at least one beam identifier comprises at least two beam identifiers divided into at least two beam identifier groups in a group based beam reporting scenario;
wherein a group sorted as a first one in the beam report is a group in which the first beam identifier is located, and
wherein beam identifiers in a same group belong to different channel measurement resource sets, respectively.

18. The method according to claim 11, wherein the beam identifier is represented by at least one of a synchronization signal block (SSB) index, a channel state information reference signal (CSI-RS) index, or a reception beam identifier.

19. The method according to claim 11, wherein the at least one beam identifier is a plurality of beam identifiers, and wherein one or more beam qualities corresponding to at least part of the plurality of beam identifiers are obtained via a prediction based on an artificial intelligence (AI) model or via measurements based on one or more reference signals transmitted by the network device.

20.-22. (canceled)

23. A terminal, comprising:
one or more processors;
one or more transceivers connected to the one or more processors; and
one or more memories for storing executable instructions of the one or more processors;
wherein the one or more processors are configured to load and execute the executable instructions transmit a beam report, wherein the beam report reports at least one beam identifier, or reports the at least one beam identifier and strength of one or more beam qualities corresponding to the at least one beam identifier.

24. A network device, comprising:
one or more processors;
one or more transceivers connected to the one or more processors; and
one or more memories for storing executable instructions of the one or more processors;
wherein the one or more processors are configured to load and execute the executable instructions to implement the beam reporting method according to claim 11.

25.-27. (canceled)
